(19) United States
(12) Patent Application Publication
(10) Pub. No.: US 2017/0020286 A1
(43) Pub. Date: Jan. 26, 2017

(54) Shelf Cover System Configured To Releasably Attach To Wire Frame Shelves

(71) Applicant: Diane Pierson, Austin, TX (US)

(72) Inventor: Diane Pierson, Austin, TX (US)

(21) Appl. No.: 15/214,070

(22) Filed: Jul. 19, 2016

Related U.S. Application Data
(60) Provisional application No. 62/194,607, filed on Jul. 20, 2015.

(51) Int. Cl. A47B 96/02; F16B 2/08; F16B 11/00; F16B 1/00

(52) U.S. Cl. CPC A47B 96/021; F16B 1/00; F16B 2/08; F16B 11/006; F16B 2001/0028

(57) ABSTRACT

In some embodiments, an apparatus may include a shelf cover including a plurality of openings and an attachment mechanism configured to extend through selected ones of the plurality of openings to secure the shelf cover to a wire shelf. In an example, the attachment mechanism may include at least one of a clip, a threaded fastener, a flange, and a fabric tie, such as a hook and loop fabric tie. The apparatus may further include a cap having a depth corresponding to a depth of the shelf cover and including an adhesive configured to adhere the cap to at least one of the wire shelf and the shelf cover. The cap may be configured couple the shelf cover to a second shelf cover.

The present disclosure is a non-provisional of and claims priority to U.S. Provisional Patent Application No. 62/194,607 filed on Jul. 20, 2015 and entitled “Shelf Cover System Configured To Releasably Attach To Wire Frame Shelves”, which is incorporated herein by reference in its entirety.

### FIELD

The present disclosure is generally related to shelf covers configured to releasably attach to wire frame shelves.

### BACKGROUND

Wire-frame shelves are commonly used in garages, pantries, closets and other areas of homes and businesses. Such shelves are formed from lengths of wire that have been arranged in a parallel configuration and bonded to two or more cross-bracing wires that extend substantially perpendicular relative to the longitudinal direction of the lengths of wire. The parallel wires and the cross-bracing wires cooperate to form flat or box-like surfaces, which can be mounted to wall to provide shelving for storage of various articles, such as clothing, food items, cutlery, dishes, cooking utensils, etc. In a garage setting, such shelving may be used to hold tools, cans, and other items.

Unfortunately, such wire shelves having openings between the wires that allow small items to fall through or that can cause small containers to tilt or tip. Further, the spacing between the wires may imprint softer objects, such as articles of clothing. In some instances, such impressions can permanently harm delicate and expensive objects. Further, since such wires are formed from coated metal, such shelves may be susceptible to scratches and may rust, causing permanent damage to items.

### SUMMARY

In some embodiments, a shelf cover system may include a cover component configured to rest on a wire shelf and an attachment component configured to couple the cover to the wire shelf. The cover component may be rigid, semi-rigid, flexible, or any combination thereof. The cover component may include slots or perforations for selectively inserting an attachment mechanism. Further, the attachment component may be releasably coupled to the cover component and to the wire shelf. The attachment component may be integrated with or fixed to the cover component or may be configured to be releasably coupled to the cover component and the wire shelf. In a particular embodiment, the attachment component may include a c-shaped clip. In another particular embodiment, the attachment component may include fasteners, such as screws, nuts, straps, or other releasable elements. In some embodiments, the cover component may include perforations to facilitate sizing the cover component to a selected length.

In some embodiments, an apparatus may include a shelf cover including a plurality of openings and an attachment mechanism configured to extend through selected ones of the plurality of openings to secure the shelf cover to a wire shelf. In an example, the attachment mechanism may include at least one of a clip, a threaded fastener, a flange, and a fabric tie, such as a hook and loop fabric tie. The apparatus may further include a cap having a depth corresponding to a depth of the shelf cover and including an adhesive configured to adhere the cap to at least one of the wire shelf and the shelf cover. The cap may be configured couple the shelf cover to a second shelf cover.

In other embodiments, a shelf cover system may include a shelf cover including a plurality of openings and a plurality of attachment mechanisms configured to extend through selected ones of the plurality of openings to secure the substrate to a wire shelf. The shelf cover system may be formed from multiple layers.

In still other embodiments, a shelf cover system may include a shelf cover including a plurality of openings and an attachment mechanism configured extend through at least one of the plurality of openings and to releasably secure the shelf cover to a wire shelf. The attachment mechanism may include at least one of a screw/flange assembly and a fabric tie.

### BRIEF DESCRIPTION OF THE DRAWINGS

FIG. 1A is a perspective view of an apparatus including a shelf cover system, in accordance with certain embodiments of the present disclosure.

FIG. 1B is a cross-sectional view of the shelf cover system of FIG. 1A.

FIGS. 2A-2D are top views of shelf systems including shelf cover systems, in accordance with certain embodiments of the present disclosure.

FIGS. 2E and 2F are side views of shelf systems including shelf cover systems, in accordance with certain embodiments of the present disclosure.

FIGS. 3A-3D are top views of shelf systems including shelf cover systems, in accordance with certain embodiments of the present disclosure.

FIGS. 4A-4E are side views of shelf cover systems, in accordance with certain embodiments of the present disclosure.

FIG. 5A is a top view of a shelf system including a shelf cover system, in accordance with certain embodiments of the present disclosure.

FIGS. 5B-5D are side views of shelf systems including shelf cover systems, in accordance with certain embodiments of the present disclosure.

FIG. 6A is a top view of a shelf cover system including a plurality of slots, in accordance with certain embodiments of the present disclosure.

FIG. 6B is a top view of a shelf cover system including a plurality of slots, in accordance with certain embodiments of the present disclosure.

FIGS. 7A-7D are side views of connectors configured to mask a joint between adjacent shelf covers, in accordance with certain embodiments of the present disclosure.

FIG. 8 is a top view of a shelf cover system, in accordance with certain embodiments of the present disclosure.

FIG. 9 is a cross-sectional view of a shelf system including a shelf cover system having multiple layers, in accordance with certain embodiments of the present disclosure.

FIG. 10 is a perspective view of a shelf system including a shelf cover system, in accordance with certain embodiments of the present disclosure.

FIGS. 11A-11B are top views of a portion of a shelf cover system including fasteners, in accordance with certain embodiments of the present disclosure.

FIG. 12 is a top view of a portion of a shelf cover system, in accordance with certain embodiments of the present disclosure.

FIGS. 13A-13D are cross-sectional views of a shelf system including a shelf cover system, in accordance with certain embodiments of the present disclosure.

FIG. 14A depicts a perspective view of a shelf cover system including a shelf cover and including a separator accessory configured to mount to the shelf cover, in accordance with certain embodiments of the present disclosure.

FIG. 14B depicts a front view of the separator accessory of FIG. 14B, in accordance with certain embodiments of the present disclosure.

FIG. 15A illustrates a front view of a shelf cover system including a separator accessory including footings configured to engage tracks provided on a shelf cover, in accordance with certain embodiments of the present disclosure.

FIG. 15B depicts a front view of the shelf cover system including the separator accessory coupled to the tracks of the shelf cover of FIG. 15A and including a stabilizer, in accordance with certain embodiments of the present disclosure.

FIG. 15C depicts a side view of a stabilizer, in accordance with certain embodiments of the present disclosure.

FIGS. 16A-16C depict shelf accessories, in accordance with certain embodiments of the present disclosure.

FIG. 17A depicts a shelf covering system including a shelf cover having a front mounting feature configured to engage a decorative edge cover, in accordance with certain embodiments of the present disclosure.

FIGS. 17B-17C illustrate a shelf covering system including a shelf cover having a mounting feature configured to receive an attachment, in accordance with certain embodiments of the present disclosure.

FIGS. 18A-18C depict attachments configured to enagage a shelf cover, in accordance with certain embodiments of the present disclosure.

FIG. 19 illustrates a foldable shelf cover, in accordance with certain embodiments of the present disclosure.

FIGS. 20A-20D depict shelf covering systems including a shelf and a shelf cover and including a plurality of attachment elements, in accordance with certain embodiments of the present disclosure.

FIGS. 21A-21B illustrate shelf covering systems including a shelf and a shelf cover and including an attachment mechanism, in accordance with certain embodiments of the present disclosure.

FIG. 22A depicts a shelf covering system, in accordance with certain embodiments of the present disclosure.

FIG. 22B depicts a shelf covering system including a shelf and a shelf cover and including a hook configured to secure a hanging rod, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Embodiments of shelf cover system may include a substrate configured to rest on top of a wire shelf to transform both the appearance and utility of wire shelf. The cover may be solid or translucent. Further, in some embodiments, a skin or overlay may be applied to the cover to change its appearance. The cover may be used to provide smooth surface that prevents small objects from falling through the wire shelf and that may prevent the wire shelf from imprinting its wire configuration onto soft items, such as articles of clothing. Further, multiple substrates may be coupled to the wire shelf, to one another, or any combination thereof to cover the wire shelf.

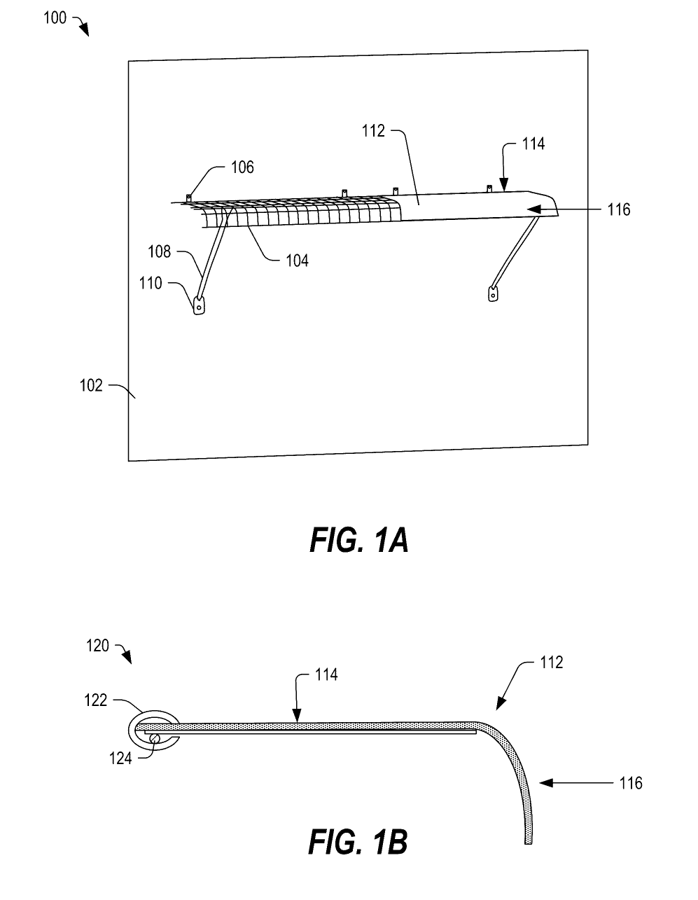

In some embodiments, each substrate may be coupled to the wire shelf by an attachment mechanism. In one particular embodiment, the attachment mechanism may include a hook integrated with the substrate and configured to curve around a wire of the wire shelf to secure the substrate to the shelf. In other embodiments, the substrate may include integrated attachment mechanisms configured to engage wires of the wire shelf to secure the substrate. In still other embodiments, the substrate may include one or more slots or openings configured to receive an attachment mechanism, such as a fastener, a clip, a strap, or other attachment mechanism to secure the substrate to the wire shelf. An embodiment of a shelf cover system is described below with respect to FIGS. 1A and 1B.

FIG. 1A is a perspective view of an apparatus 100 including a shelf cover system 112, in accordance with certain embodiments of the present disclosure. The apparatus 100 may include a shelving unit coupled to a structure 102, such as a wall. The shelving unit may include a wire shelf 104 including an attachment mechanism 106 configured to couple the wire shelf 104 to the structure 102. Further, the shelving unit may include a support arm 108 coupled to the structure 102 by a flange 110.

The shelf cover system 112 may include a cover or liner, which may be flexible, semi-rigid, rigid, or any combination thereof and which may be releasably coupled to the shelf 104. As used herein, the term “semi-rigid” may refer to a substrate that can be flexible, but that has a thickness sufficient to resist bending to conform to open areas between wires of the wire shelf 104 such that the semi-rigid cover may extend over the wire shelf 104 to provide a substantially smooth surface. The shelf cover system 112 may include a top surface 114 and a front portion 116. The top surface 114 may provide the substantially smooth surface, and the front portion 116 may overhang at least a portion of a front of the shelf 104 providing an enhanced aesthetic appearance and improved functionality, at least with respect to small objects.

In some embodiments, the shelf cover system 112 may be formed from a unitary sheet of material of substantially uniform material thickness (within manufacturing tolerances) and material composition. In other embodiments, the shelf cover system 112 may be formed from different materials, may have spatially varying thicknesses, or any combination thereof. In an embodiment, the shelf cover system 112 may include a first portion formed from a first material and at least one second portion formed from a second material. The first material and the second material may have different material properties. For example, the first material may be more flexible than the second material. Alternatively, the flexibility may be achieved by varying the thickness of the material. Other embodiments are also possible.

FIG. 1B is a cross-sectional view 120 of the shelf cover system 112 of FIG. 1A. The shelf cover system 112 includes the top surface 114 and the front portion 116. Further, the shelf cover system 112 can include an attachment mechanism 122, which may releasably couple the shelf cover system 112 to a wire 124 of the wire shelf 104. In some embodiments, the attachment mechanism 122 may include a c-shaped clip configured to snap over a back edge of the shelf cover system 112 and over at least one wire of the wire shelf 104. The c-shaped clip (attachment mechanism 122) may have an opening sized to fit over the shelf cover system 112 and configured to temporarily expand to fit over the wire 124 before contracting to apply a compressive force to the top surface 114 and the wire 124. The c-shaped clip may apply a clamping (compressive) force against the shelf cover system 112 and the wire 120 to prevent the shelf cover system 112 from moving relative to the wire shelf 104. Other types of attachment mechanisms are also possible.

In some embodiments, the shelf cover system 112 may be configured to partially cover a front portion of the wire shelf 104, leaving room for a hanger to be hung from the front lip of the shelf. Additionally, in some embodiments, the shelf cover system 112 may include perforations, which may be used to cut the shelf cover system 112 to a selected size. Further, embodiments of the shelf cover system 112 may vary in depth (front to back) to correspond to the various shelf depths, such as, but not exclusive to, 12-inch, 16-inch, 20-inch, or other sized shelf options. Additionally, the shelf cover system 112 may be formed in various lengths (side to side) depending on market need. In some embodiments, the shelf cover system 112 may include perforations, holes, slots, or other openings to facilitate custom sizing (such as by cutting) or to receive a fastener, a flange, a strap, or another mechanism to secure the shelf cover system to the wire shelf 104.

Further, the shelf cover system 112 may be configured to fit any number of different styles of wire shelf units. Typically, the wire shelf may have at least two wire horizontal support rods running lengthwise and welded to a plurality of parallel wires that extend substantially perpendicular to the support rods. The parallel wires and the horizontal support rods cooperate to form a repeating pattern of wires. The distance between the wires can vary as can the number of support rods, depending on the implementation. In some embodiments, the wire spacing may be as small as ⅜ths of an inch (measured center-to-center). The shelf cover system 112 may prevent small items from falling between the wires, may prevent small containers from tipping, and may protect soft items, such as articles of clothing, from acquire a wire shelf imprint or from being damaged by the wire shelf (either by staining or by catching on a protrusion).

In certain embodiments, the slot spacing, slot configuration, or any combination thereof may be varied to accommodate different wire shelves, which may have different wire spacing and sizes. Further, in some embodiments, other types of openings may be used to facilitate the coupling.

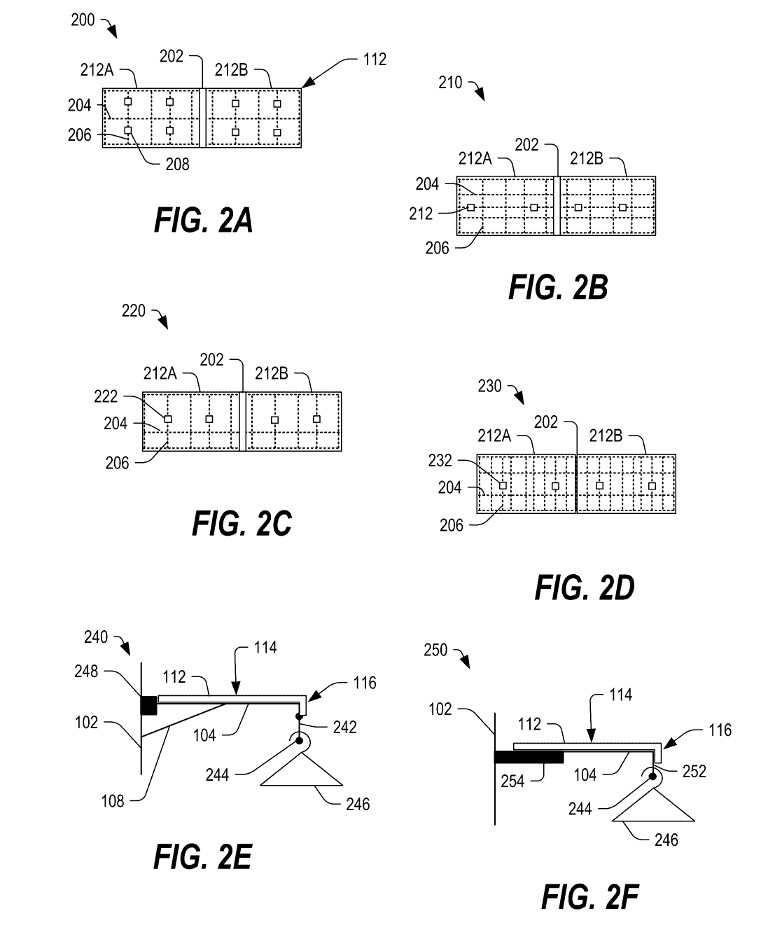

FIGS. 2A-2D are top views of shelves including shelf cover systems, in accordance with certain embodiments of the present disclosure. In FIG. 2A, a shelf system 200 is shown that includes a wire frame shelf including first wires 204 and second wires 206. In some embodiments, the first wires 204 may extend substantially perpendicular to a mounting surface and the second wires 206 may extend substantially parallel to the mounting surface, or vice versa. The system 200 further includes a shelf covering system 112 including a first shelf cover 212A and a second shelf cover 212B. The system 200 further includes a shelf cover connector 202 configured to cover the joints between adjacent shelf covers (e.g., between the first shelf cover 212A and the second shelf cover 212B). Further, each shelf cover 212A and 212B can include one or more fastening mechanisms 208, such as a clip, a releasable flange, an adhesive strip, a hook and loop fastening fabric, another fastener, or any combination thereof. In the illustrated example, the fastening mechanisms 208 are configured to attach to one of the first wires 204 and the second wires 206.

FIG. 2B includes a top view of a shelf covering system 210 including a shelf having first wires 204 and second wires 206. The shelf covering system 210 includes shelf covers 212A and 212B and includes the connector 202. Further, in the illustrated example, the attachment mechanisms 208 may be configured to couple to at least a first wire 204.

FIG. 2C includes a top view of a shelf covering system 220, including a shelf having first wires 204 and second wires 206 in a different wire configuration from the shelves shown in FIGS. 2A and 2B. Further, attachment mechanisms 222 may be configured to couple the shelf cover 212A and 212B to selected ones of the second wires 206.

FIG. 2D depicts a top view of a shelf covering system 230, including a shelf having support wires 204 and cross wires 206. The shelf has a different wire configuration as compared to the shelf shown in FIGS. 2A, 2B, and 2C. The shelf covering system 230 may include shelf covers 212A and 212B and a connector 202. Further, attachment mechanisms 232 may couple the shelf covers 212A and 212B to cross wires 206.

In the embodiments shown in FIGS. 2A-2D, the attachment mechanisms 208, 212, 222, and 232 may be configured to couple to a selected one of the first wires 204 and the second wires 206.

FIGS. 2E and 2F are side views of shelves including shelf cover systems, in accordance with certain embodiments of the present disclosure. In some embodiments, the shelves may have a space between the support structure (such as the wall) and the back edge of the shelf, which space may be approximately ¼^{th} to ⅓^{rd} of an inch.

In FIG. 2E, a shelf system is shown and generally indicated at 240. The shelf system 240 includes a wire shelf 104 coupled to a structure 102 by a mounting structure 248 and by a support arm 108. The mounting structure 248 may include a bracket, a flange, or another coupling element. The shelf system 240 may include a shelf cover 112 having a top surface 114 and a front portion 116 configured to cover at least a portion of a front edge 242 of the wire shelf 104. An uncovered portion of the wire shelf 104 may include a support rod 244 from which a hanger 246 may be hung. While the embodiment depicted in FIG. 2E appears to have a sharp corner, it should be appreciated that the edge may be beveled, rounded, or otherwise adjusted to eliminate or reduce the corner edge.

FIG. 2F is a side view of a system 250 including a shelf cover, in accordance with certain embodiments of the present disclosure. The shelf cover system 250 may include a mounting structure 254, which is configured to couple the wire shelf 104 to the structure 106. The shelf cover 112 includes a top portion 114 and a front portion 116. The front portion 116 may be configured to cover a portion of a front of the wire shelf 104. An uncovered or exposed portion 250 may include a wire rod 244 from which a hanger 246 may be hung. While the embodiment depicted in FIG. 2F appears to have a sharp corner, it should be appreciated that the edge may be beveled, rounded, or otherwise adjusted to eliminate or reduce the corner edge.

In some embodiments, an attachment mechanism may releasably couple the shelf cover 112 to the mounting structure 248 or 254 or to the wire shelf 104. The attachment mechanism may include a fastener, a clip, a strap, a hook and loop fabric, another attachment mechanism, or any combination thereof.

In some embodiments, the shelf cover 112 may include cut out portions configured to fit around the mounting structure 248 or 254. Alternatively, the shelf cover 112 may include openings, slots, or other features configured to facilitate engagement of attachment mechanisms with the mounting structure 248 or 254. Other embodiments are also possible.

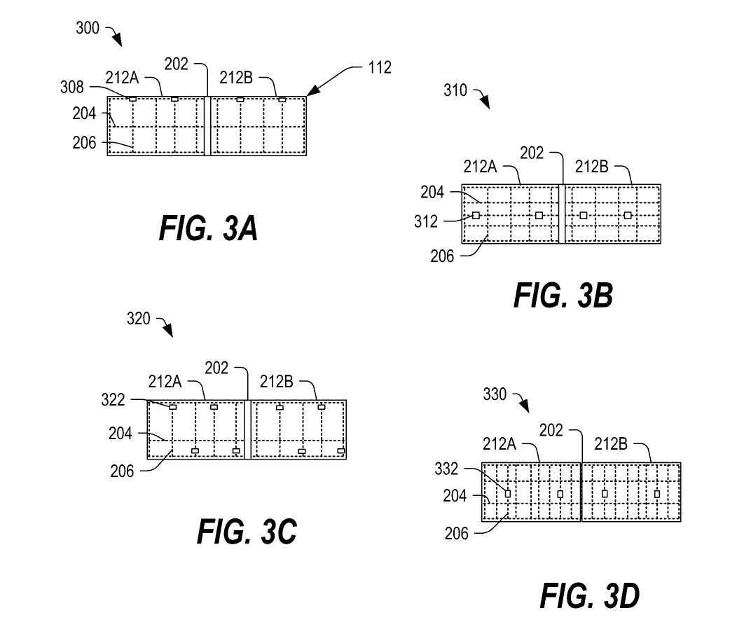

FIGS. 3A-3D are top views of shelf systems including shelf cover systems, in accordance with certain embodiments of the present disclosure, The embodiments of FIGS. 3A-3D include all of the features of the embodiments of FIGS. 2A-2D, except that the attachment mechanisms have been replaced with slots or openings sized to receive a an attachment mechanism, such as a clip, a releasable flange, a hook and loop fastening fabric, an adhesive strip, a buckle/strap assembly, a screw/flange assembly, another fastener, or any combination thereof

In FIG. 3A, a shelf system 300 is shown that includes a wire frame shelf including first wires 204 and second wires 206. In some embodiments, the first wires 204 may extend substantially perpendicular to a mounting surface and the second wires 206 may extend substantially parallel to the mounting surface, or vice versa. The system 300 further includes a shelf covering system 112 including a first shelf cover 212A and a second shelf cover 212B. The system 300 further includes a shelf cover connector 202 configured to cover the joints between adjacent shelf covers (e.g., between the first shelf cover 212A and the second shelf cover 212B). Further, each shelf cover 212A and 212B can include one or more slots or openings 308, which may be aligned to one of the first wires 204 and the second wires 206 and which may be sized to receive an attachment mechanism.

FIG. 3B includes a top view of a shelf covering system 310 including a shelf having first wires 204 and second wires 206. The shelf covering system 310 includes shelf covers 212A and 212B and includes the connector 202. Further, in the illustrated example, the slots or openings 312 may be configured to facilitate coupling of an attachment mechanism to at least a first wire 204 through one of the shelf covers 212A and 212B.

FIG. 3C includes a top view of a shelf covering system 320, including a shelf having first wires 204 and second wires 206 in a different wire configuration from the shelves shown in FIGS. 2A and 2B. Further, attachment mechanisms 322 may be configured to to facilitate coupling of an attachment mechanism to at least a second wire 206 through one of the shelf covers 212A and 212B.

FIG. 3D depicts a top view of a shelf covering system 330, including a shelf having support wires 204 and cross wires 206. The shelf has a different wire configuration as compared to the shelves shown in FIGS. 2A, 2B, and 2C. The shelf covering system 330 may include shelf covers 212A and 212B and a connector 202. Further, slots or openings 332 may facilitate coupling of an attachment mechanism to at least one of a first wire 204 and a second wire 206 through one of the shelf covers 212A and 212B. Other embodiments are also possible.

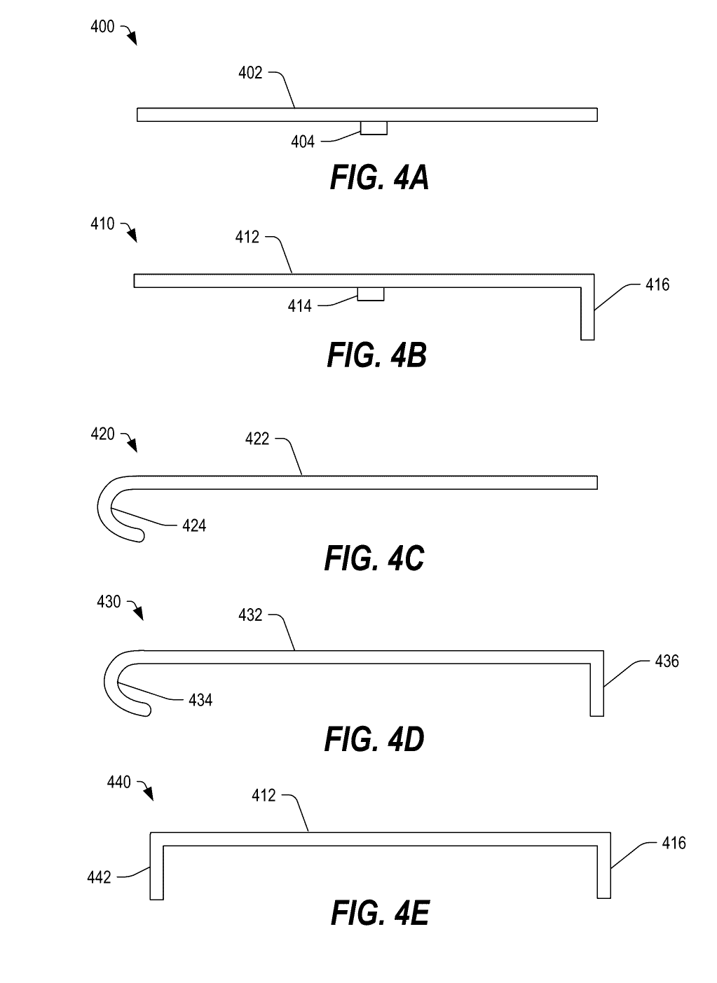

FIGS. 4A-4E are side views of shelf cover systems, in accordance with certain embodiments of the present disclosure. In FIG. 4A, a shelf cover system 400 may include a shelf cover 402 including an attachment mechanism 404, which may be approximately centered along a bottom surface of the shelf cover 402. In some embodiments, the attachment mechanism 404 may be moveable and may be repositioned by inserting it through an opening to secure the shelf cover 402 to the wire shelf.

In FIG. 4B, a shelf cover system 410 is shown that includes a shelf cover 412 having an overhang or front portion 416, which may overhang a front of a wire shelf. The shelf cover 412 may include an attachment mechanism 414, which may be substantially centered with respect to a depth of the shelf cover 412.

FIG. 4C depicts a shelf cover system 420 having a top portion 422 configured to rest on a wire shelf and including a hook portion 424. The hook portion 424 may fit around a rear edge of a wire shelf to prevent the shelf cover from moving relative to the wire shelf. In an example, the shelf cover system 420 may be tilted to fit the hook portion 424 over the rear edge of the wire shelf and then the shelf cover system 420 may be tilted toward horizontal to install the shelf cover system 420.

In FIG. 4D, a shelf cover system 430 is shown that includes a top portion 432 and a hook portion 434. The shelf cover system 430 further includes a front portion 436, which may fit over and mask a front edge of the wire shelf.

In FIG. 4E, a shelf cover system 440 is shown that may include a top portion 412, a front overhang portion 416 and a rear overhang portion 442. The rear overhang portion 442 and the front overhang portion 416 may cooperate to prevent the shelf cover 440 from shifting position relative to the wire shelf 104.

In some embodiments, the shelf cover systems 400, 410, 420, 430, and 440 in FIGS. 4A-4E may include cutout portions configured to fit over a shelf mounting system, such as a bracket or front mounting wire shelfing that is stabilized by attaching vertical poles to the front of the wires as well as attaching to the wall in the back. In some embodiments, the shelf cover systems 400, 410, 420, 430, and 440 may be formed from a flexible material. Other embodiments are also possible.

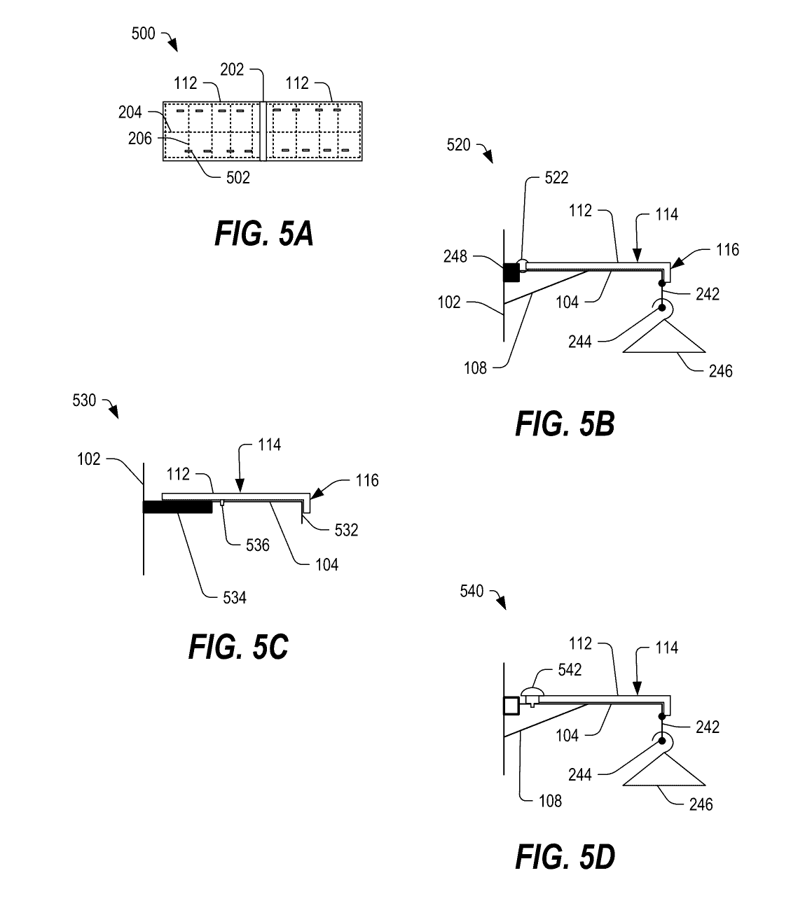

FIGS. 5A is a top view of a shelf system 500 including a shelf cover system, in accordance with certain embodiments of the present disclosure. The shelf system 500 includes a wire shelf formed of support wires 204 and cross bars 206. Further, the shelf system 500 includes shelf covers 112 and a connector 202. The shelf cover 112 may include one or more slots 502 through which a fastener mechanism may be inserted to secure the shelf cover 112 to the wire shelf In some embodiments, the slots 502 may include openings, perforations, slits, holes, or any combination thereof. Slots 502 may be formed at the front and back, just the back, in the middle, or any combination thereof, allowing the slots to correspond with the various positions of the wires of each shelf type. In some embodiments, the slots 502 may be partial openings or perforations, which a user may have to expand using scissors, a knife, a finger, or another instrument.

In some embodiments, the shelf cover 112 may be thin and rigid. In some embodiments, the shelf cover 112 may be flexible (may be stored in a rolled up form) so that it can be rolled up for storage and unrolled for installation. The shelf cover 112 may be white, opaque with a design, or clear. In some embodiments, the shelf cover 112 may fold over the front edge of the wire shelf to provide a nice visual finish for the front of the shelf. For hanging closet options, the fold portion may be about half of the depth of the front edge. In some embodiments, the fold or overhang portion may be a selected length, such as approximately three inches.

In some embodiments, a plastic tie, a hook and loop fabric fastener or tie (such as Velcro®), a twist tie (i.e., coated wire), a metal tie, a fabric tie, or any combination thereof may be extended through a slot 502 and wrapped around a wire of the wire shelf 104 to secure the shelf cover 112.

FIGS. 5B-5D are side views of shelf cover systems, in accordance with certain embodiments of the present disclosure. In FIG. 5B, the shelf cover 112 may not have a slot. The shelf cover system 520 of FIG. 5B shows an attachment mechanism 522, which may fit over a rear edge of the shelf cover 112 and couple to or releasably attach to at least one wire of the wire shelf 104. In some embodiments, the attachment mechanism 522 may include a plastic c-shaped clip that can be looped through one of the slots in or looped over the end of the shelf cover 112 and extended over one of the wires of the wire shelf 104 to secure the shelf cover 112. Alternatively or in addition, the attachment mechanism 522 may include a hook and loop fabric tie or other material configurable to releasably fasten the shelf cover 112 to the shelf.

In FIG. 5C, a shelf cover system is depicted and generally designated at 530. The shelf system 530 includes a mounting structure 534 configured to couple the wire shelf 104 to a structure 102 (such as a wall). The shelf system 530 further includes a shelf cover 112, which includes an attachment mechanism 536 configured to couple to at least one wire of the wire shelf 104. In some embodiments, the attachment mechanism 536 may include a clip attached to the shelf cover 112 at a middle portion, at a front portion, before the last horizontal crossbar of the wire shelf 104, or any combination thereof. Alternatively or in addition, the attachment mechanism 522 may include a hook and loop fabric tie or other material configurable to releasably fasten the shelf cover 112 to the shelf.

FIG. 5D depicts a shelf cover system 540 including a wire shelf 104 and a shelf cover 112 coupled to the wire shelf 104. The shelf cover system 540 includes an attachment mechanism 542, which may be configured to releasably secure the shelf cover 112 to the wire shelf 104. In some embodiments, the attachment mechanism 542 may extend between adjacent wires of the wire shelf 104 and may turn to apply a compressive force to the shelf cover 112, securing the shelf cover 112 to the wire shelf 104. In some embodiments, the attachment mechanism 542 may include a threaded fastener (such as a screw) and a fitting including a lower stabilizer, which may be tightened to secure the shelf cover 112 to the wire shelf 104. In a particular embodiment, the threaded fastener or the fitting may be integrated with the shelf cover 112.

In some embodiments, the attachment mechanism 542 may include a flange portion, which may be poked through a slot 502 in the shelf cover 112 and turned to extend over at least one wire of the wire shelf 104 to secure the shelf cover 112 to the wire shelf 104. Alternatively or in addition, the attachment mechanism 522 may include a hook and loop fabric tie or other material configurable to releasably fasten the shelf cover 112 to the shelf.

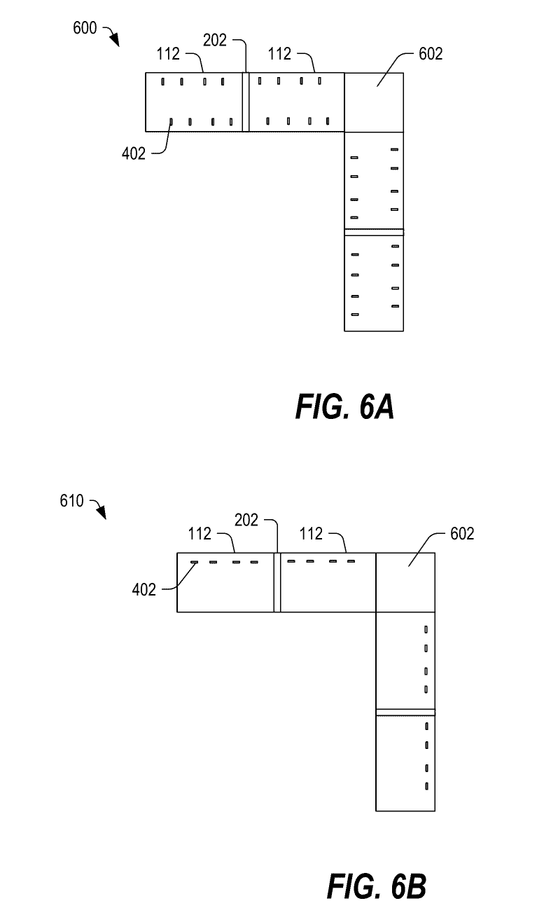

FIG. 6A is a top view of a shelf cover system 600, in accordance with certain embodiments of the present disclosure. The shelf cover system 600 may include a plurality of shelf covers 112 and connectors 202. Each shelf cover 112 may include one or more slots 502, which may include perforations, holes, openings, or any combination thereof and through which one or more attachment mechanisms may be inserted to secure the shelf cover 112 to the wire shelf 104. Further, the shelf cover system 600 may include a corner cover 602, which may be used to cover a corner wire shelf. In some embodiments, the corner cover 602 may attach to shelf covers 112 on adjacent sides to provide a shelf portion. In the illustrated example, the one or more slots 504 extend in a direction that is substantially perpendicular to a length of the shelf cover 112.

FIG. 6B is a top view of a shelf cover system 610 including a plurality of slots 502, in accordance with certain embodiments of the present disclosure. The shelf cover system 610 includes all of the elements of the shelf cover system 600 of FIG. 6A, except that the slots 502 are oriented such that they extend in a direction corresponding to a length of the shelf cover 112.

In an alternative embodiment, the slots 502 may extend in a direction that is at an angle, such as forty-five degrees, relative to the length of the shelf cover 112. In this example, the angle may allow for attachment to wire shelves having a variety of different wire spacings and configurations.

In the examples of FIGS. 6A-6B, a variety of attachment mechanisms may be used to couple the shelf covers 112 to a wire shelf. Such attachment mechanisms can include fasteners, ties, clips, flange/screw assemblies, hook and loop fabric ties, other fasteners, or any combination thereof.

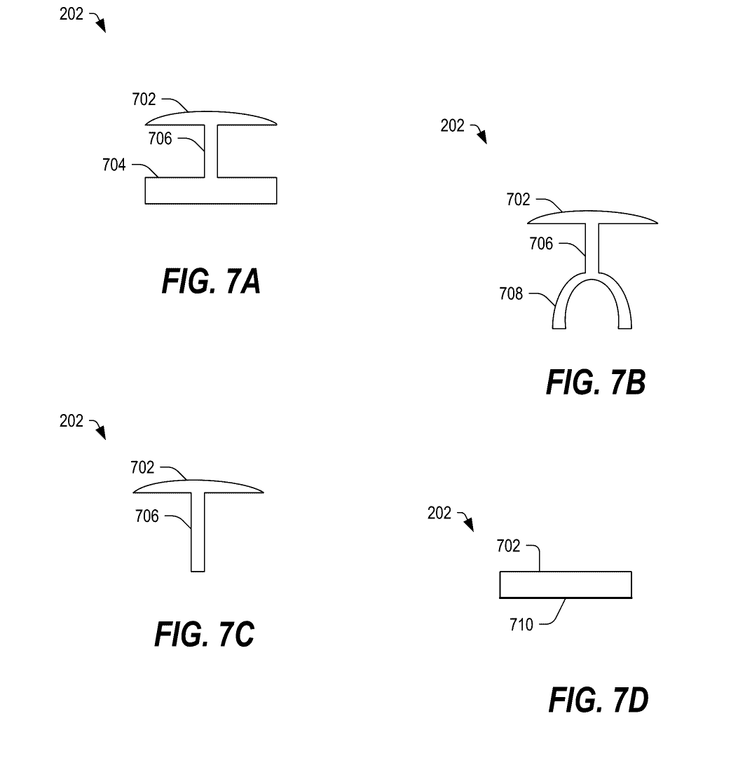

In some embodiments, the connectors 202 may have a variety of different shapes. The connectors 202 are configured to couple adjacent shelf covers 112 and to mask the seam between shelf covers 112. Embodiments of connectors 202 are described below with respect to FIGS. 7A-7D.

FIG. 7A is a side view of a connector 202 having an I-beam type of configuration. The connector 202 includes a first horizontal portion 702 and a second horizontal portion 704, which are spaced apart by a vertical portion 706. In some embodiments, the vertical portion 706 has a length that is approximately equal to a width of a shelf cover 112.

FIG. 7B is a side view of a connector 202 having a C-shaped clip configuration. The connector 202 may include a horizontal portion 702 and a vertical portion 706 extending from the horizontal portion 702. Further, a c-shaped clip 708 may be coupled to the vertical portion 706. In the embodiment of FIG. 7B, the connector 202 may be clipped to a wire of the wire shelf 104, and the shelf covers 112 may be slid under the horizontal portion 702, which may press the shelf cover 112 against the wire shelf 104.

FIG. 7C is a side view of a connector 202 having a T-shaped configuration. The connector 202 may include the horizontal portion 702 and the vertical portion extending therefrom. The T-shaped connector 202 may be inserted between (dropped into the gap between) adjacent shelf covers 112 to mask the joints.

In some embodiments, the connector 202 may having a substantially tapered upper surface, to provide a gradual and smooth transition from one shelf cover to the next shelf cover. In other embodiments, the connector 202 may have a thin, rectangular shape. Other transitions are also possible.

FIG. 7D is a side view of a connector 202 having an adhesive bottom layer. The connector 202 has a horizontal portion 702 having a top surface and having a lower surface that includes a peel-and-stick adhesive layer configured to be glued to a top surface of the shelf cover 112 to secure the shelf cover 112 to an adjacent shelf cover or to the wire shelf 104.

In an alternative embodiment, the connector 202 of FIG. 7D may include slots on opposing edges to receive the edges of the shelf covers 112. The connector 202 may also include the adhesive bottom layer to secure the connector 202 to the wire shelf. Other embodiments are also possible.

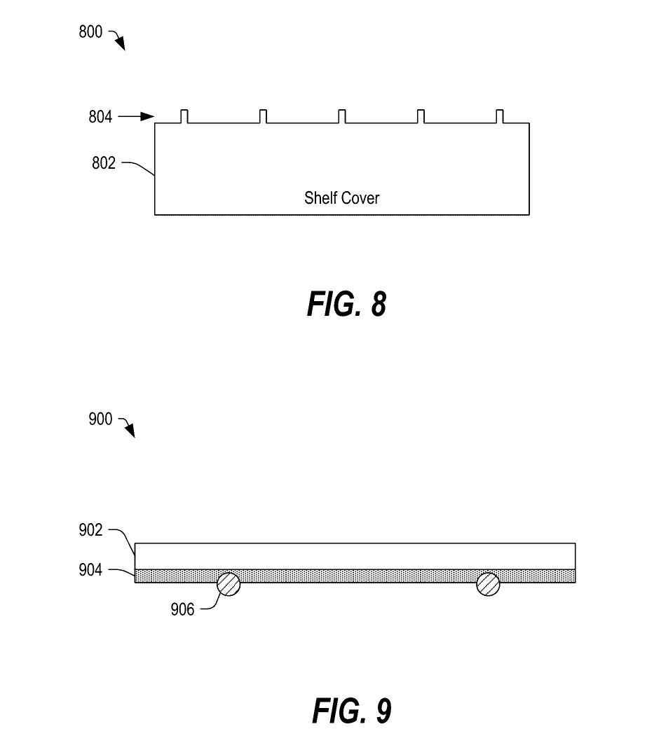

FIG. 8 is a top view of a shelf cover system 800, in accordance with certain embodiments of the present disclosure. The shelf cover system 800 may include a shelf cover 802 including extensions or hooks 804, which may protrude from a rear edge of the shelf cover 802. In some embodiments, the extensions or hooks 804 may be flexible and may be bent over a rear edge of the wire shelf 104.

FIG. 9 is a cross-sectional view of a shelf cover system 900 including multiple layers, in accordance with certain embodiments of the present disclosure. The shelf cover system 900 may include a rigid upper layer 902 to provide a smooth top surface and a compressible lower layer 904 configured to rest on wires 906 of the wire shelf. The weight of the upper layer 902 and items resting on the upper layer cooperate to compress the lower layer 904, and the compressible lower layer 904 prevents the shelf cover from moving relative to the wire shelf.

In some embodiments, the compressible lower layer 904 may be provided in strips. In some embodiments, rather than a compressible lower layer 904, compressible strips may include an adhesive side configured to stick to an underside of the rigid upper layer 902. The strips may be distributed across a bottom of the rigid upper layer 902 to provide cushioning and compressive adhesion between the rigid upper layer 902 and the wires of the wire shelf.

In some embodiments, the shelf cover system 900 may include a first portion having a first thickness and a second portion including a second thickness that is less than the first thickness. In this example, the different thicknesses may be achieved by adding or omitting layers or by varying the thickness of one or more layers. In an example, a thinner area may provide more flexibility than a thicker area. Alternatively, rather than varying the thickness, the material composition may be varied to provide different material parameters, such as flexibility, texture, and other material parameters. Other embodiments are also possible.

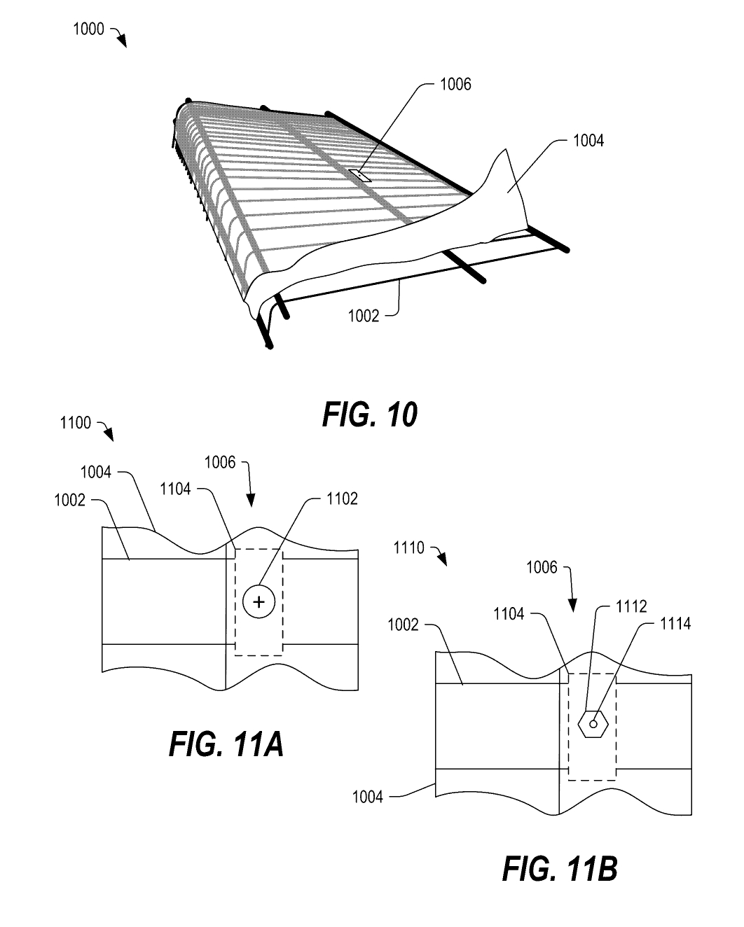

FIG. 10 is a perspective view of a shelf cover system 1000, in accordance with certain embodiments of the present disclosure. The shelf cover system 1000 may include a shelf cover 1004 formed from a sheet of semi-rigid material, which may be unrolled onto the wire shelf 1002 and which may be peeled back as shown. In some embodiments, an attachment mechanism 1006 may be inserted through a slot or opening in the shelf cover 1004 to couple the shelf cover 1004 to the wire shelf 1002.

FIGS. 11A-11B are top views of a portion of a shelf cover system, in accordance with certain embodiments of the present disclosure. In FIG. 11A, a portion of a shelf cover and an associated attachment mechanism is shown and generally indicated at 1100. The portion 1100 includes a shelf cover 1004 extending over wires 1002 of a wire shelf. The portion 1100 further includes an attachment mechanism 1006 including a flange portion 1104 and a fastener 1102, which may be a threaded fastener, such as a screw. In some embodiments, the flange portion 1104 may be configured to overlap at least one wire of a wire shelf and a fastener 1102 may be inserted into a threaded opening in the flange portion 1104 and tightened to secure the shelf cover 1004 to the wires 1002 by compressive force.

In one embodiment, the fastener 1102 may be extended through a slot or opening 502 in the shelf cover 1004. In another example, the fastener 1102 may include a threaded portion that may be screwed into the shelf cover 1004 and through the other side to mate with the flange portion 1104. Other embodiments are also possible.

FIG. 11B depicts an alternative embodiment of an attachment mechanism 1006 having a threaded post 1114, which may be extended through an opening in the shelf cover 1004 and to which a threaded nut 1112 may be tightened to secure the shelf cover 1004. In another example, the fastener 1102 may include a threaded portion that may be screwed into the shelf cover 1004 and through the other side to mate with the flange portion 1104. Other embodiments are also possible.

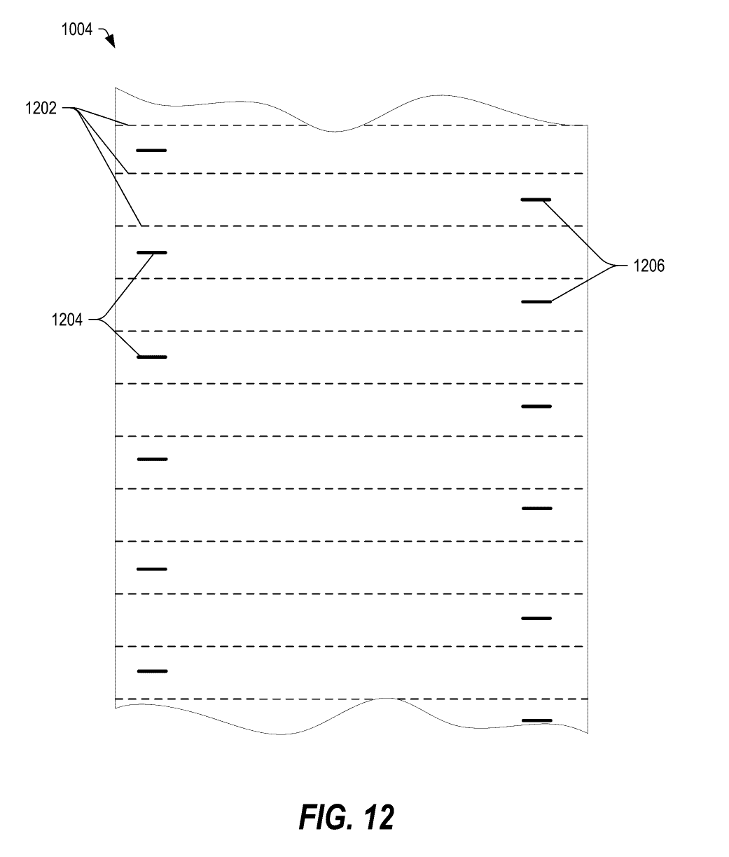

FIG. 12 is a top view of a portion 1004 of a shelf cover system, in accordance with certain embodiments of the present disclosure. The portion 1004 includes a plurality of perforations 1202 extending horizontally relative to a length of the shelf cover. The length of the shelf cover may be tailored to fit the wire shelf by cutting the shelf cover along a selected perforation. Further, the portion 1004 may include a first plurality of slots 1204 and a second plurality of slots 1206, which may be offset from one another and on opposite sides of the shelf cover. A fastener, a tie, a strap, or another attachment mechanism may be inserted through a selected one or more of the slots 1204 and 1206 to engage the wire shelf

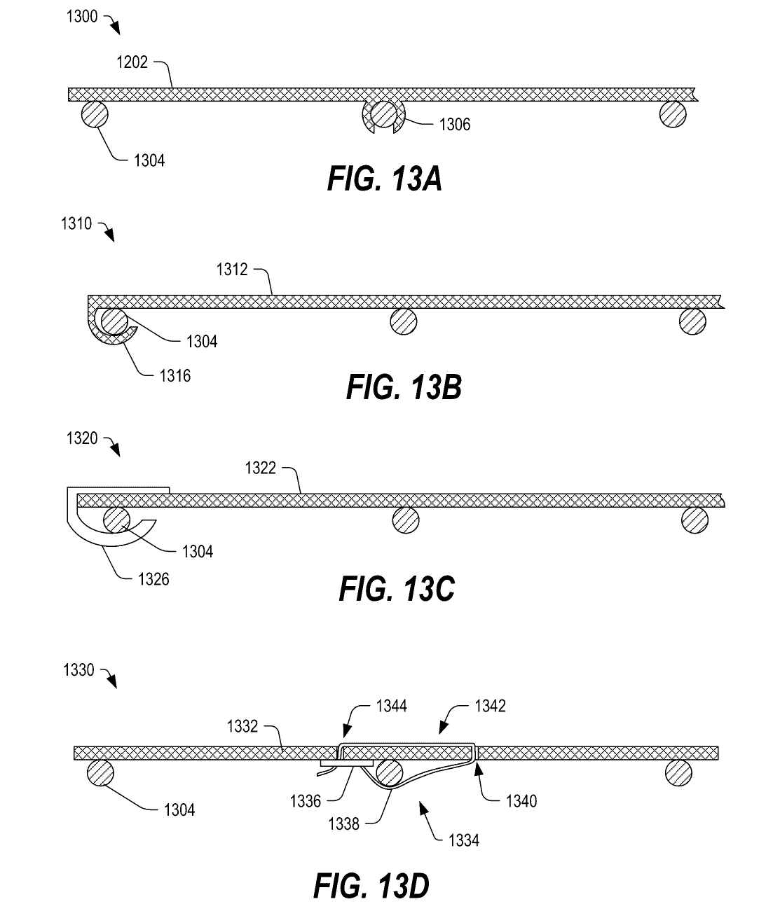

FIGS. 13A-13D are cross-sectional views of a shelf cover system, in accordance with certain embodiments of the present disclosure. In FIG. 13A, a shelf cover system is disclosed and generally indicated at 1300. The shelf cover system 1300 includes a horizontal shelf portion 1302 configured to rest on wires 1304 of a wire shelf. The shelf cover system 1300 further includes a clip 1306 configured to fit over one of the wires of the wire shelf to secure the horizontal shelf portion 1302 to the wire shelf. In some embodiments, the clip 1306 may be integrated with the horizontal shelf portion 1302.

FIG. 13B shows a shelf cover system 1310 including a horizontal shelf portion 1312 and including a hook portion 1316 configured to extend over one of the wires 1304 of a wire shelf. The hook portion 1316 may fit over a wire 1304 to secure the shelf cover 1312 from moving.

FIG. 13C depicts a shelf cover system 1320 including a horizontal shelf cover 1322 configured to rest on wires 1304 of a wire shelf. The shelf cover system 1320 may include a c-shaped clip 1326 configured to fit over an edge portion of the horizontal shelf cover 1322 and to fit over a wire of the wire shelf to secure the shelf cover 1322.

FIG. 13D depicts a shelf cover system 1330 including a shelf cover portion 1332 configured to rest on wires 1304 of a wire shelf. The shelf cover portion 1332 includes openings 1340 and 1344. Further, an attachment mechanism 1334 includes a buckle portion 1336 and a strap 1338 extending from the buckle portion 1336 under a wire 1304, through the opening 1340, across a portion 1342 of a top surface of the shelf cover 1332, through the opening 1344, and into or through the buckle 1336 to secure the shelf cover 1332 to the wire 1304.

In an alternative embodiment, a hook and loop fabric strap or fabric tie may be used to secure the shelf cover 1332 to the wire 1304. Other embodiments are also possible.

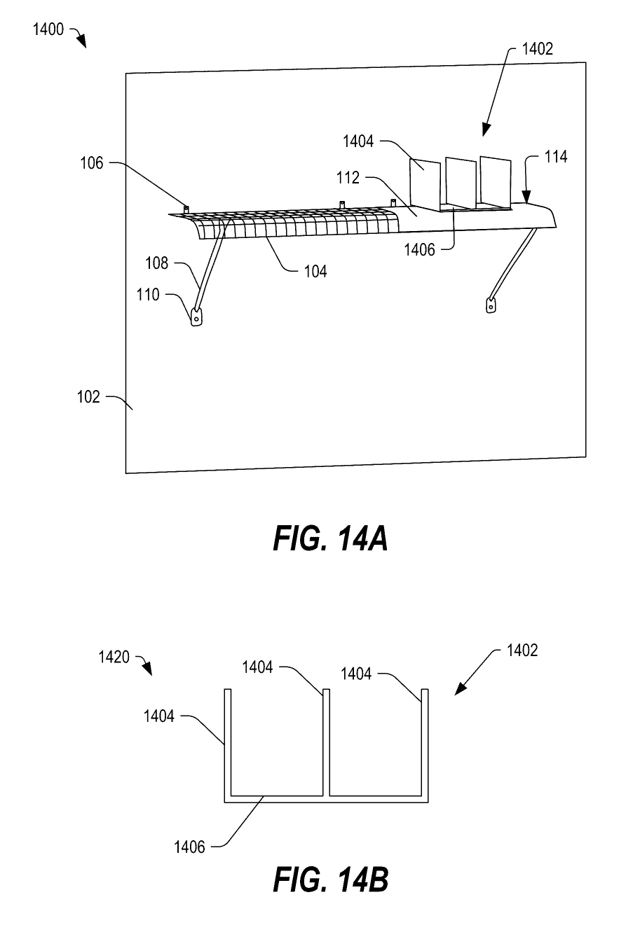

In some embodiments, in addition to providing a smooth surface, the shelf cover described herein may act as a base to enable modular add-ons, which can be used to customize the utility of the cover. In some examples, the shelf cover may be configured to enable slide-in or clip-on decorative attachments. Further, various organizer modules may be used in conjunction with the shelf cover. One possible organize is described below with respect to FIG. 14A.

FIG. 14A depicts a perspective view of a shelf cover system 1400 including a shelf cover 112 and including a separator accessory 1402 configured to mount to the shelf cover 112, in accordance with certain embodiments of the present disclosure. In the illustrated example, the separator accessor 1402 may include a base 1406 configured to contact the shelf cover 112 and a plurality of separator walls 1404, which may extend in a direction that is substantially perpendicular to the base 1406. In other embodiments, the separator walls 1404 may extend at an angle other than perpendicular.

While only three separator walls 1404 are shown, it should be appreciated that any number of separator walls 1404 may be included. In an example, the base 1406 may be provided with one or more slots configured to receive additional separator walls 1404, allowing for adjustable spacing to enable use with different sizes of files, magazines, books, and other materials.

FIG. 14B depicts a front view 1420 of the separator accessory 1402 of FIG. 14B, in accordance with certain embodiments of the present disclosure. The separator walls 1404 may be spaced apart to allow sufficient space to receive folded sweaters, towels, or other items. In other instances, additional separator walls 1404 may be provided to facilitate use with respect to files, papers, and other items.

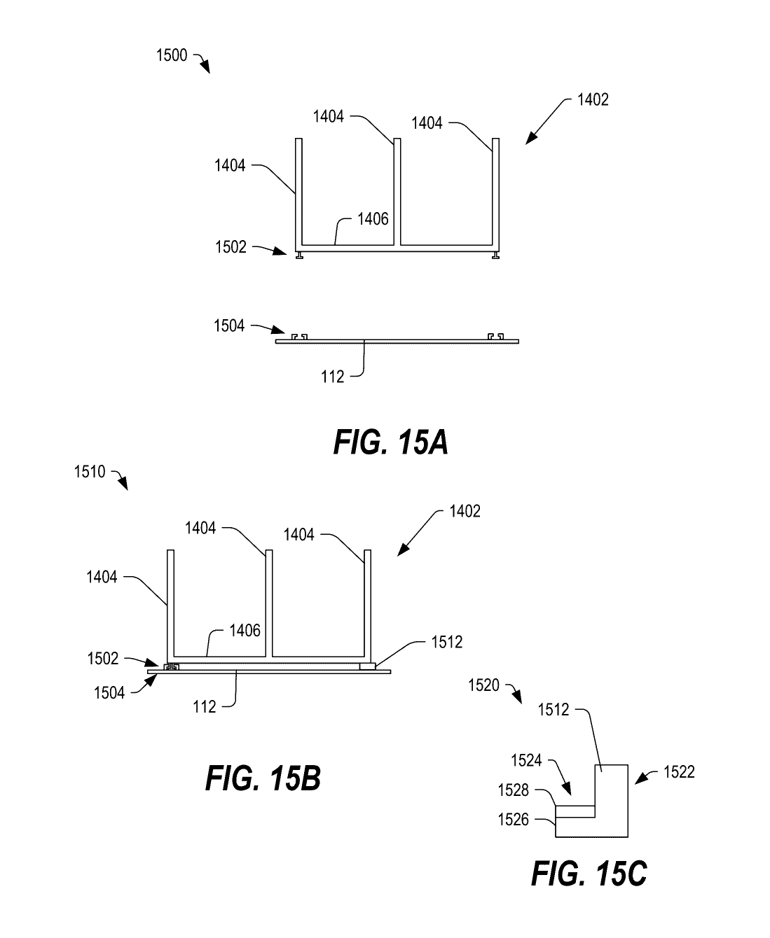

FIG. 15 illustrates a front view of a shelf cover system 1500 including a separator accessory 1402 including footings 1502 configured to engage tracks 1504 provided on a shelf cover 112, in accordance with certain embodiments of the present disclosure. In the illustrated example, the footings 1502 may be substantially t-shaped and may be configured to engage one or more features 1504 formed on or coupled to the surface of the shelf cover 112. In this example, the tracks 1504 may extend from a front to a back (against the wall) of the shelf cover 112. In another example, the tracks 1504 may be extend along the length of the shelf cover 112.

In some embodiments, the footings 1502 may include a small peg-style of foot. In other embodiments, the footings 1502 may include an extended feature configured to extend along at least a portion of the track 1504. Other embodiments are also possible.

In operation, the footings 1502 and the tracks 1504 can cooperate to secure the accessory 1402 to the shelf and to prevent movement of the accessory 1402 relative to the shelf. Friction between the footings 1502 and the tracks 1504 may resist movement in the direction of the tracks 1504, and the sidewalls of the tracks 1504 may restrict lateral movement. Alternatively, the footings 1502 and the tracks 1504 may be omitted, and slots may be provided in at least a portion of the accessory 1402 to receive a fastener or other attachment mechanism configured to couple the accessor 1402 to at least one of the shelf cover 112 and the shelf. Thus, the footings 1502 and the tracks 1504 (or the slots and the fastener or other attachment mechanism) can provide a relatively stable accessory 1402 that resists tilting.

In some embodiments, a stabilizer may be included that can lock the footings 1502 within the tracks 1504 in order to prevent the accessory 1402 from sliding out of the tracks. One possible example of a stabilizer is described below with respect to FIGS. 15B and 15C.

FIG. 15B depicts a front view of the shelf cover system 1510 including the separator accessory 1402 coupled to the tracks 1504 of the shelf cover 112 of FIG. 15A and including a stabilizer 1512, in accordance with certain embodiments of the present disclosure. The stabilizer 1512 may include a component sized to fit into an end of the track 1504 to prevent the footings 1502 of the separator accessor 1402 from slipping out of the track 1504. In some embodiments, the stabilizer 1512 may include a flexible portion configured to fit within and engage the track 1504 to secure the stabilizer 1512 to the end of the track 1504. In some embodiments, the stabilizer 1512 may include a rigid portion configured to cover the end of the track 1504. Other embodiments are also possible.

FIG. 15C depicts a side view 1520 of a stabilizer 1512, in accordance with certain embodiments of the present disclosure. The stabilizer 1512 may include a front- facing portion 1522 and a track engagement portion 1524. The track engagement portion 1524 may include a base portion 1526 and a center portion 1528 configured to engage the shape of the track 1504. In other embodiments, the track engagement portion 1524 may include a clip, a clasp, or another feature configured to engage the track 1504, the shelf cover 112, the shelf, or any combination thereof

In certain embodiments, the facing portion 1522 and the track engagement portion 1524 may be formed from different materials. In an example, the front facing portion 1522 may be formed from a rigid material (such as a rigid plastic), and the track engagement portion 1524 may be formed from a flexible material (such as rubber).

It should be appreciated that the stabilizer 1512 depicted in FIGS. 15B and 15C is configured to fit the track 1504. Other shapes or other configurations of the stabilizer 1512 are also possible that may fit onto the end of the track 1504 or otherwise provide a stop to prevent the footings 1502 from sliding out of the track 1504. If the shape of the track 1504 changes, the shape of the stabilizer 1512 may also be changed to perform the stop function.

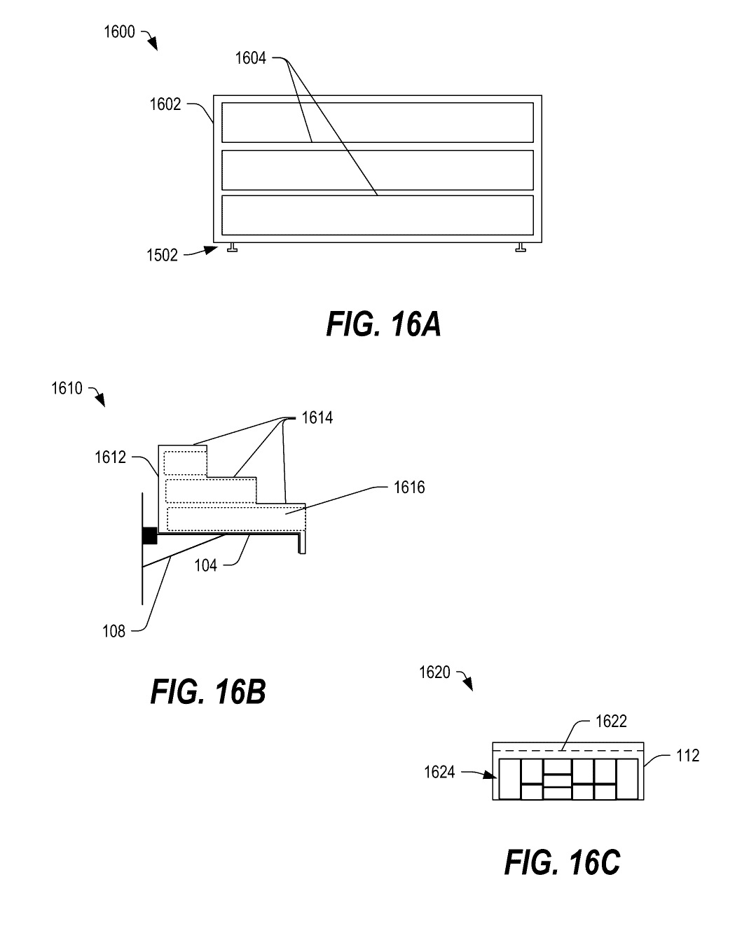

FIGS. 16A-16C depict shelf accessories, in accordance with certain embodiments of the present disclosure. In FIG. 16A, a shelving accessory 1602 includes a plurality of shelves 1604. The shelving accessory 1602 may include footings 1502 configured to engage tracks provided in a shelf cover. Alternatively, the shelving accessory 1602 may include slots or other features (as discussed above) that can be configured to couple the accessory 1602 to the shelf or to the shelf cover.

In some embodiments, the shelving accessory 1602 may include drawer slides and drawers. In other embodiments, the shelving accessory 1602 may be formed from several modules stacked on top of one another and coupled together, allowing a user to configure the size of the shelving accessory 1602. Similarly, the modular version may include drawers and associated drawer slides. Other embodiments are also possible.

FIG. 16B depicts a shelf cover system 1610 including a stadium-style of shelving unit 1612 including multiple steps or shelves 1614. The shelving unit 1612 can be coupled to a shelf cover or directly to the shelf and can be used for cans, spices, or other items. In some embodiments, a bottom portion of the shelving unit 1612 may include one or more drawers, recesses, or other features for storage of small items, such as small spices, pens, tape, can openers, and the like (as indicated in phantom at 1616).

FIG. 16C illustrates a shelf cover system 1620 including a shelf cover 112, a plurality of slots 1622 configured to receive attachment mechanisms to couple the shelf cover 112 to the shelf. Further, the shelf cover system 1620 can include a plurality of storage structures 1624, which may include containers, bins, indentations, separators, or any combination thereof. In some embodiments, the plurality of storage structures 1624 may be configured to snap together to provide a customizable arrangement. Alternatively, the plurality of storage structures 1624 may be presented as a unitary structure formed from a single piece of plastic or from a plurality of physically coupled structures. Other embodiments are also possible.

In some embodiments, these storage structures 1624 may be used for spices, jewelry, medicine, office supplies, coins, and other small items. Further, the storage structures may include one or more footings configured to engage tracks on the shelf cover. Alternatively, the storage structures may include loops or slots that can be used to couple the storage structures 1624 to the shelf, for example, using a tie or fabric loop.

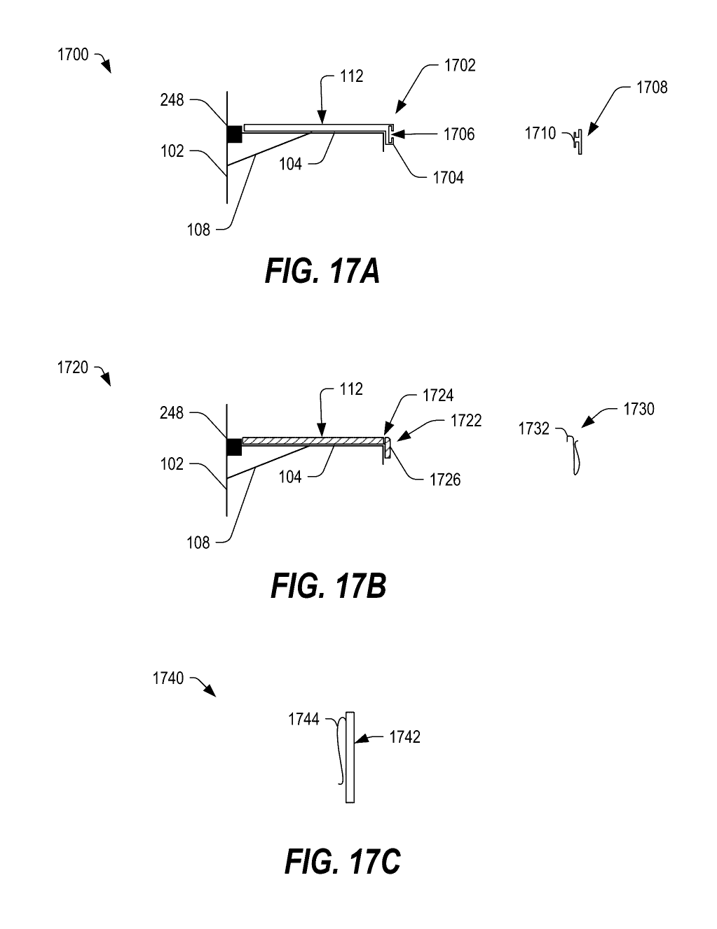

FIG. 17A depicts a shelf covering system 1700 including a shelf cover 112 having a front mounting feature 1702 configured to engage a decorative edge cover 1708, in accordance with certain embodiments of the present disclosure. In the illustrated example, the mounting feature 1702 may include a slot or tracks 1704 defining an opening 1706 and configured to engage a T-shaped footing 1710 disposed on the attachment 1708. The mounting feature 1702 may be configured to receive and secure a attachment 1708 that can be slid into the slot and held in place or clipped in. In some embodiments, the attachment 1708 may include a decorative front-facing layer.

In some embodiments, in lieu of the decorative front-facing layer or in addition to the decorative front-facing layer, the attachment 1708 can include a hook, a loop, a cup, another organizer feature, or any combination thereof In some embodiments, rather than a slot or track 1704, the attachment features may be reversed, such that the slot or track 1704 is presented on the attachment 1708, and the T-shaped footing 1710 is provided on the shelf cover 112. In another embodiment, instead of providing a T-shaped footing 1710 and a slot or track 1710, the attachment 1708 may be coupled to the front of the shelf using an an adhesive, a tie, a fabric component (such as a hook and loop fabric), or any combination thereof.

FIGS. 17B-17C illustrate a shelf covering system 1720 including a shelf cover 112 having a mounting feature 1722 configured to receive an attachment 1730, in accordance with certain embodiments of the present disclosure. The mounting feature 1722 may include a front face 1726 and an opening 1724 sized to receive a hook feature 1732 of the attachment 1730. The attachment 1730 may define a clip or loop that can be used to secure an object.

In FIG. 17C, an attachment 1740 is depicted that may include a hook portion 1744 and a front-facing layer 1742. The hook portion 1744 may be coupled to the opening 1724 or to another portion of a wire shelf. Other embodiments are also possible.

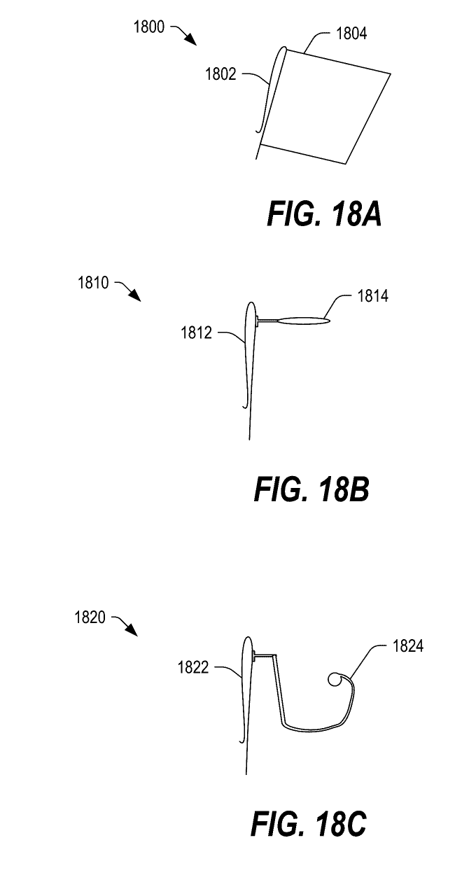

FIGS. 18A-18C depict attachments configured to enagage a shelf cover, in accordance with certain embodiments of the present disclosure. In FIG. 18A, an attachment 1800 includes a clip portion 1802 coupled to a cup 1804. In certain embodiments, the clip portion 1802 may be coupled to the shelf cover 112 or to the front of a wire shelf

In FIG. 18B, an attachment 1810 includes a clip portion 1812 coupled to a loop 1814, which may be configured to hold a tool or device. For example, the loop portion 1814 may be configured to hold a screw driver, a hammer, or another tool. In some examples, the clip portion 1812 may be coupled to the shelf cover 112 or to the front of a wire shelf.

In FIG. 18C, an attachment 1820 includes a clip portion 1822 coupled to a hook 1824. For example, the hook 1824 may be configured to hold a garment, a hand towel, or another object. In some examples, the clip portion 1822 may be coupled to the shelf cover 112 or to the front of a wire shelf.

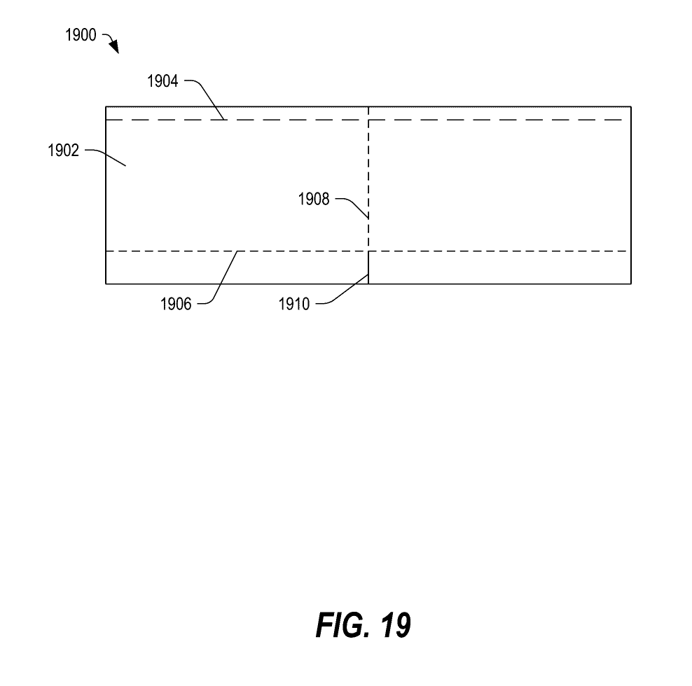

FIG. 19 illustrates a foldable shelf cover 1900, in accordance with certain embodiments of the present disclosure. The foldable shelf cover 1900 may be formed from a reinforced or covered cardboard material, similar to a board game. The foldable shelf cover 1900 may include a substrate 1902 having slots 1904 formed therein. Further, the foldable shelf cover 1900 may include a longitudinal fold line 1906 and a lateral fold line 1908. By making the shelf cover foldable, the shipping may be simplified and the costs may be reduced. Other embodiments are also possible.

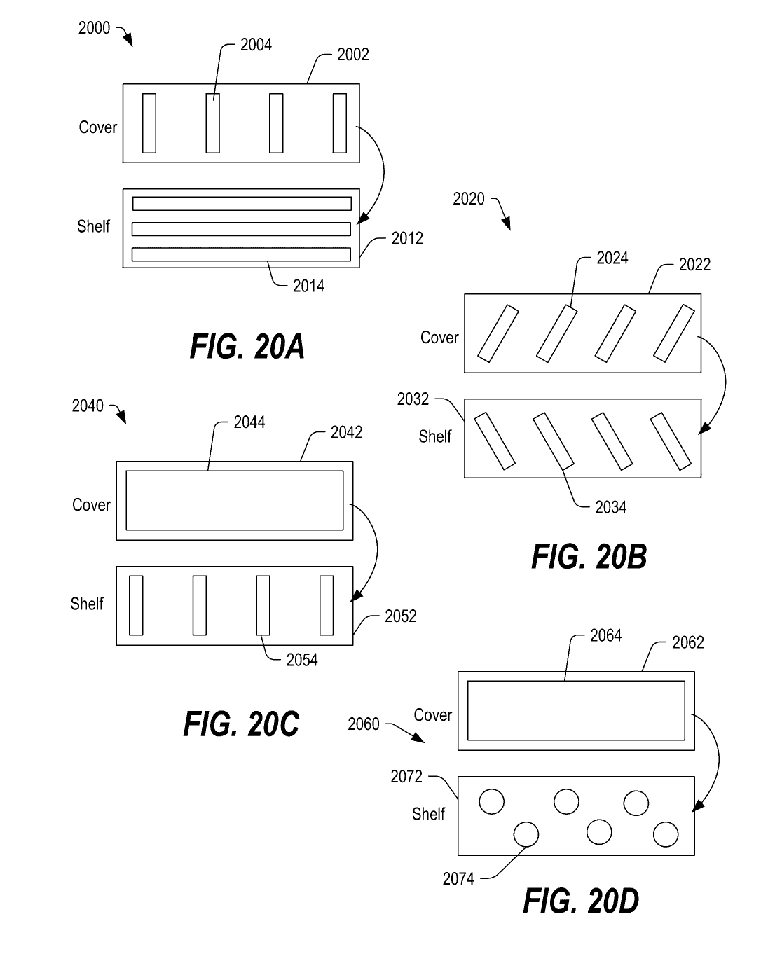

FIGS. 20A-20D depict shelf covering systems including a shelf and a shelf cover and including a plurality of attachment elements, in accordance with certain embodiments of the present disclosure. The shelf covering systems in FIGS. 20A-20D may utilize adhesive fasteners, hook and loop fabric fasteners, other fasteners, or any combination thereof. The shelf covering systems in FIGS. 20A-20D may be used in connection with wire shelves, such as those described above with respect to FIG. 1, for example, or may be used with solid shelves. The shelf covers may be formed from plastic, wood, granite, rubber, laminate, or another material or composite.

In FIG. 20A, the shelf cover system 2000 includes a shelf 2012 and a cover 2002. The cover 2002 may include one or more attachment elements 2004 attached to a bottom surface, which attachment elements 2004 may be configured to mate with corresponding attachment elements 2014 on the shelf 2012. The attachment elements 2004 may be formed from rectangular pieces of hook or loop fabric across the width of the cover 2002. The attachment elements 2014 may extend lengthwise across the shelf 2012.

In FIG. 20B, the shelf cover system 2020 may include a cover 2022 and a shelf 2032. The cover 2022 may include diagonal attachment elements 2024 configured to mate with corresponding diagonal attachment elements 2034 on the shelf 2032.

In FIG. 20C, the shelf cover system 2040 may include a cover 2042 and a shelf 2052. The cover 2042 may include a rectangular attachment element 2044 extending over a large portion of the bottom surface of the cover 2042. The shelf 2052 may include a plurality of lateral attachment elements 2054.

In FIG. 20D, the shelf cover system 2060 may include a cover 2062 and a shelf 2072. The cover 2062 may include a rectangular attachment element 2064 extending over a large portion of the bottom surface of the cover 2062. The shelf 2072 may include a plurality of circular attachment elements 2074.

In each of the embodiments of FIGS. 20A-20D, the attachment elements of the cover portions are configured to mate with the corresponding attachment portions on the shelf to secure the cover to the shelf. The shelf 2012, 2032, 2052, or 2072 may be a solid shelf or a wire shelf, depending on the implementation. The attachment elements 2014, 2034, 2054, or 2074 may be formed from a hook or loop fabric and may be attached to the shelf 2012, 2032, 2052, or 2072 by an adhesive, by a tie, or by another attachment feature. Other embodiments are also possible.

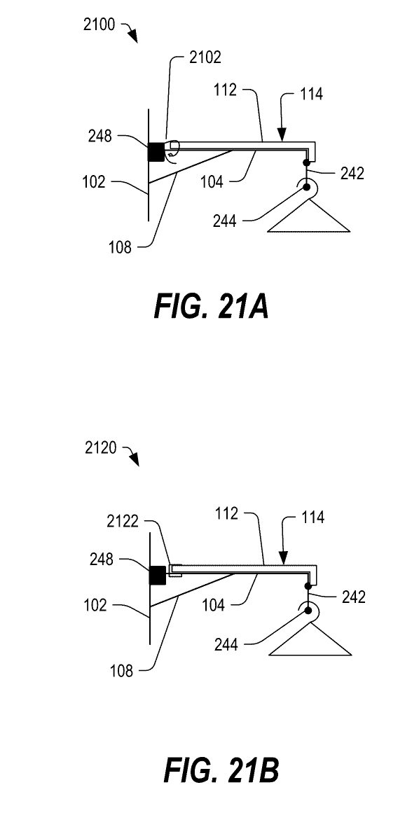

FIGS. 21A-21B illustrate shelf covering systems including a shelf and a shelf cover and including an attachment mechanism, in accordance with certain embodiments of the present disclosure. In FIG. 21A, a shelf covering system 2100 is shown that includes a shelf cover 112 including a slot through which a fastener 2102 can be threaded. The fastener 2102 may be configured to couple the caps to the wire shelving. The fastener 2102 may be formed from plastic, hook and loop fabric, a zip tie (plastic or hood and loop), a flat twist tie (coated wire), metal, or any combination thereof.

In the illustrated example, the fastener 2102 may include a clip configured to engage a slot of the cover 112 and to fit around a portion of the wire shelf 104 to secure the cover 112 to the shelf 104. In many instances, there is a space between the wire shelf and the wall due to the mounting structure, leaving room for the clip. In this example, the clip (or fastener 2102) may be formed from a rigid material or from a moldable material (such as a bendable wire).

In FIG. 21B, a shelf covering system 2120 is shown that include a shelf cover 112 coupled to the wire shelf by a clip 2122. In this example, the clip 2122 may be formed from a substantially rigid material that can be bent enough to fit the end of the clip 2122 into a slot of the shelf cover 112 and fit over the wire shelf 104 to secure the shelf cover 112.

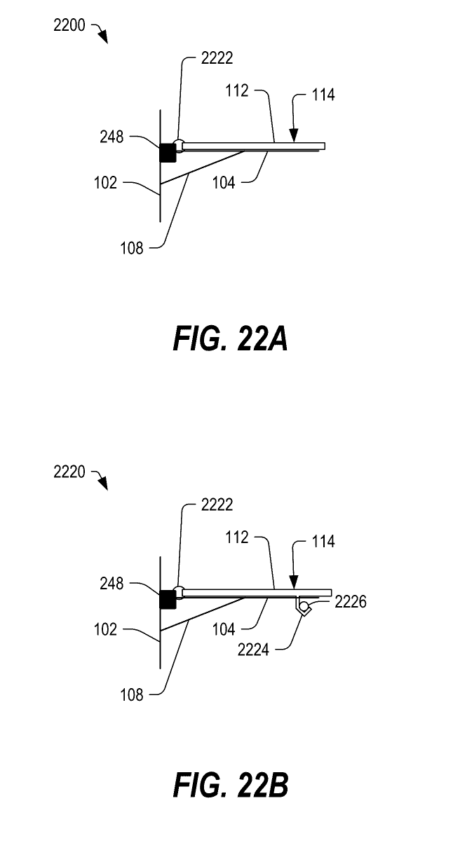

FIG. 22A depicts a shelf covering system 2200, in accordance with certain embodiments of the present disclosure. In the illustrated example, a fastener 2222 may couple the shelf cover 112 to the shelf 104. In this example, the shelf cover 112 may extend slightly past an end of the shelf 104. The fastener 222 can be formed from plastic, hook and loop fabric, a zip tie (plastic or fabric), a flat twist tie (coated wire), metal, or any combination thereof.

FIG. 22B depicts a shelf covering system 2200 including a shelf 104 and a shelf cover 112 and including a hook 2224 configured to secure a hanging rod 2226, in accordance with certain embodiments of the present disclosure. In some examples, the hook 2224 may be integrally formed as part of the shelf cover 112. Alternatively, the hook 2224 may be coupled to the shelf cover 112 to provide the hangar function.

In the illustrated example, the hook 2224 is set back from the end of the shelf 112. In other embodiments, the hook 2224 may be closer to the end of the shelf 112. Other embodiments are also possible.

In conjunction with the shelf cover systems, attachment mechanisms, and connectors described above with respect to FIGS. 1-22B, a shelf cover system may include an upper surface, a lower surface to engage a wire shelf, and an attachment mechanism. The attachment mechanism may include an adhesive, a compressible layer, a flange/fastener mechanism, another fastener, or any combination thereof In some embodiments, a connector may include a horizontal portion configured to engage an upper surface of adjacent shelf covers. The connector may also include a lower horizontal portion, a vertical portion, a c-shaped clip portion, or any combination thereof.

In some embodiments, the shelf cover may include an attachment mechanism configured to receive one or more attachments, including organizers, shelves, drawers, separators, or other organizational elements. In some embodiments, the shelf cover may include a front mounting feature (such as a track or T-shaped footing) or an opening that can engage a corresponding feature of an attachment to secure an aesthetic cover to the front of the shelf, to secure an additional organizer to the front of the shelf, to provide another function, or any combination thereof.

In the embodiments described above with respect to FIGS. 1-22B, it should be appreciated that elements depicted in one figure may be combined with elements from another without departing from the scope of this disclosure. Further, workers skilled in the art will recognize that changes may be made in form and detail without departing from the scope of this disclosure.

What is claimed is:

1. An apparatus comprising:
a shelf cover including a plurality of openings;
an attachment mechanism configured to extend through selected ones of the plurality of openings to secure the shelf cover to a wire shelf; and
a cap having a depth corresponding to a depth of the shelf cover and including an adhesive configured to adhere the cap to at least one of the wire shelf and the shelf cover, the cap configured to couple the shelf cover to a second shelf cover.

2. The apparatus of claim 1, wherein the shelf cover comprises:
a horizontal surface portion; and
a front portion configured to extend over a front edge of the wire shelf

3. The apparatus of claim 2, wherein the front portion includes a front mounting apparatus configured to secure at least one of a decorative element and an organizational element to the front edge of the wire shelf.

4. The apparatus of claim 2, wherein the shelf cover further comprises a rear portion configured to extend over a rear edge of the wire shelf.

5. The apparatus of claim 1, wherein the shelf cover comprises:
a rigid upper layer; and
a compressible lower layer, the compressible lower layer configured to engage wires of the wire shelf

6. The apparatus of claim 1, wherein the attachment mechanism comprises a c-shaped clip configured to couple the shelf cover to a wire of the wire shelf.

7. The apparatus of claim 1, wherein the attachment mechanism comprises:
a flange configured to engage one or more wires of the wire shelf; and
a threaded fastener configured to extend through the shelf cover and to couple to the flange to releasably secure the shelf cover to the wire shelf

8. The apparatus of claim 1, wherein the attachment mechanism comprises at least one of a hook and loop fabric and a strap including a buckle.

9. The apparatus of claim 1, wherein the cap includes at least one of an I-beam shape and a T-shape and configured to cover a joint between adjacent shelf covers of a plurality of shelf covers.

10. The apparatus of claim 1, further comprising:
one or more attachment features coupled to a top surface of the shelf cover; and
an organizational module including an attachment feature configured to engage at least one of the one or more attachment features of the top surface to secure the organization module to the shelf cover.

11. The apparatus of claim 10, wherein the organizational module includes at least one of a separator apparatus, a stepped structure, a drawer apparatus, and a plurality of storage structures.

12. A shelf cover system comprising:
a shelf cover including a plurality of openings;
a plurality of attachment mechanisms configured to extend through selected ones of the plurality of openings to secure the substrate to a wire shelf; and
a cap having a depth corresponding to a depth of the shelf cover and including an adhesive configured to adhere the cap to at least one of the wire shelf and the shelf cover, the cap configured to couple the shelf cover to a second shelf cover.

13. The shelf cover system of claim 12, wherein the shelf cover comprises a plurality of layers, including a top surface layer having a first material property and a shelf engagement layer having a second material property configured to stabilize and hold the cover on wire shelving.

14. The shelf cover system of claim 13, wherein the shelf engagement layer is compressible and wherein the top surface layer is rigid.

15. The shelf cover system of claim 12, wherein the plurality of openings comprise slots.

16. The shelf cover system of claim 12, wherein the plurality of attachment mechanisms include:
a flange configured to engage at least one wire of the wire shelf; and
a fastener configured to extend through one of the plurality of openings and to couple to the flange to secure the shelf cover to the wire shelf.

17. The shelf cover system of claim 12, wherein the plurality of attachment mechanisms include:
a hook and loop fabric tie configured to extend through one of the plurality of openings and around at least one wire of the wire shelf to secure the shelf cover to the wire shelf.

18. The shelf cover system of claim 12, wherein the cap includes at least one of an I- beam shape and a T-shape and configured to cover a joint between adjacent shelf covers of a plurality of shelf covers.

19. A shelf cover system comprising:
a shelf cover including a plurality of openings;
an attachment mechanism configured extend through at least one of the plurality of openings and to releasably secure the shelf cover to a wire shelf; and
a cap including an adhesive configured to adhere the cap to at least one of the wire shelf and the shelf cover, the cap configured to couple the shelf cover to a second shelf cover.

20. The shelf cover system of claim 19, further comprising:
one or more attachment features coupled to a top surface of the shelf cover; and
an organizational module including an attachment feature configured to engage at least one of the one or more attachment features of the top surface to secure the organization module to the shelf cover.

21. The apparatus of claim 20, wherein the organizational module includes at least one of a separator apparatus, a stepped structure, a drawer apparatus, and a plurality of storage structures.

22. The apparatus of claim 19, wherein the shelf cover comprises:
a horizontal surface portion; and
a front portion configured to extend over a front edge of the wire shelf

23. The apparatus of claim 22, wherein the front portion includes a front mounting apparatus configured to secure at least one of a decorative element and an organizational element to the front edge of the wire shelf.
